(19) United States
(12) Patent Application Publication
(10) Pub. No.: US 2014/0157202 A1
(43) Pub. Date: Jun. 5, 2014

(54) METHOD FOR SETTING PERIPHERAL DEVICE REMOVING INTERFACE, ELECTRONIC DEVICE AND COMPUTER READABLE STORAGE MEDIUM

(71) Applicant: WISTRON CORPORATION, New Taipei City (TW)

(72) Inventors: Sophi Xiao, New Taipei City (TW); Jingjing Hua, New Taipei City (TW)

(73) Assignee: Wistron Corporation, New Taipei City (TW)

(21) Appl. No.: 13/861,379

(22) Filed: Apr. 12, 2013

(30) Foreign Application Priority Data
Nov. 30, 2012 (CN) 201210507268.5

(51) Int. Cl. G06F 3/0481

(52) U.S. Cl. CPC G06F 3/04817
USPC 715/839

(57) ABSTRACT

A method for setting peripheral device removing interface includes steps of displaying a first peripheral device removing interface in an electronic device, wherein the electronic device has N first connecting ports and N is a positive integer larger than one; displaying N first icons in the first peripheral device removing interface; and moving the N first icons in the first peripheral device removing interface to positions corresponding to the N first connecting ports.

### BACKGROUND OF THE INVENTION

1. Field of the Invention

The invention relates to a method for setting a peripheral device removing interface and, more particularly, to a method allowing a user to remove a peripheral device rapidly and safely in a peripheral device removing interface.

2. Description of the Prior Art

Nowadays, universal serial bus (USB) is the most popular peripheral bus in computer industry and consumer electronic products. USB connecting port can be used to connect various peripheral devices, such as keyboard, mouse, flash driver, card reader, digital camera, personal digital assistant (PDA), smart phone, and so on. Due to plug and play capability and usage convenience, USB is available to most of applications in the market. So far there are lots of USB applications developed by peripheral and computer manufactures and there are also lots of drivers and programs developed correspondingly.

Currently, lots of electronic devices (e.g. personal computer, flat computer, notebook, etc.) are equipped with a plurality of USB connecting ports for connecting different peripheral devices simultaneously. When a user wants to remove one specific peripheral device, he/she has to click a safety removing icon in a toolbar first. Afterward, the names of the peripheral devices, which are connected to the USB connecting ports of the electronic device, will be displayed on the screen. At this time, the user usually has to inquire and check the name of the peripheral device, so as to prevent the other peripheral devices, which are transmitting data, from being removed and then damaged. The aforesaid operation manner is very complicated and inefficient for the user. Furthermore, if the user is not familiar with the name of the peripheral device, it is possible for the user to remove the wrong peripheral device, which is transmitting data and then the peripheral device will be damaged.

### SUMMARY OF THE INVENTION

The invention provides a method for setting a peripheral device removing interface, an electronic device and a computer readable storage medium, so as to solve the aforesaid problems.

According to the claimed invention, a method for setting peripheral device removing interface comprises steps of displaying a first peripheral device removing interface in an electronic device, wherein the electronic device has N first connecting ports and N is a positive integer larger than one; displaying N first icons in the first peripheral device removing interface; and moving the N first icons in the first peripheral device removing interface to positions corresponding to the N first connecting ports.

According to the claimed invention, the step of moving the N first icons in the first peripheral device removing interface to positions corresponding to the N first connecting ports comprises steps of connecting a peripheral device to an i-th first connecting port of the N first connecting ports, wherein i is a positive integer smaller than or equal to N; determining that a j-th first icon of the N first icons is corresponding to the i-th first connecting port and changing a display color of the j-th first icon, wherein j is a positive integer smaller than or equal to N; and moving the j-th first icon in the first peripheral device removing interface to a position corresponding to the i-th first connecting port.

According to the claimed invention, the method further comprises steps of displaying the j-th first icon by a first color when the peripheral device is connected to the i-th first connecting port and is transmitting data; displaying the j-th first icon by a second color when the peripheral device is connected to the i-th first connecting port and is idle; and displaying the j-th first icon by a third color when the peripheral device has not been connected to the i-th first connecting port yet.

According to the claimed invention, the method further comprises steps of displaying a second peripheral device removing interface in the electronic device when a hub is connected to one of the N first connecting ports, wherein the hub has M second connecting ports and M is a positive integer larger than one; displaying M second icons in the second peripheral device removing interface; and moving the M second icons in the second peripheral device removing interface to positions corresponding to the M second connecting ports.

According to the claimed invention, the step of moving the M second icons in the second peripheral device removing interface to positions corresponding to the M second connecting ports comprises steps of connecting a peripheral device to a p-th second connecting port of the M second connecting ports, wherein p is a positive integer smaller than or equal to M; determining that a q-th second icon of the M second icons is corresponding to the p-th second connecting port and changing a display color of the q-th second icon, wherein q is a positive integer smaller than or equal to M; and moving the q-th second icon in the second peripheral device removing interface to a position corresponding to the p-th second connecting port.

According to the claimed invention, the method further comprises steps of displaying the q-th second icon by a first color when the peripheral device is connected to the p-th second connecting port and is transmitting data; displaying the q-th second icon by a second color when the peripheral device is connected to the p-th second connecting port and is idle; and displaying the q-th second icon by a third color when the peripheral device has not been connected to the p-th second connecting port yet.

According to the claimed invention, the N first connecting ports and the M second connecting ports are universal serial bus connecting ports.

According to the claimed invention, an electronic device comprises a storage unit for storing a peripheral device removing program; a processing unit electrically connected to the storage unit and used for executing the peripheral device removing program; N first connecting ports electrically connected to the processing unit, N being a positive integer larger than one; a display unit electrically connected to the processing unit, the display unit displaying a first peripheral device removing interface and displaying N first icons in the first peripheral device removing interface when the peripheral device removing program is executed; and an input unit electrically connected to the processing unit and used for moving the N first icons in the first peripheral device removing interface to positions corresponding to the N first connecting ports.

According to the claimed invention, when a peripheral device is connected to an i-th first connecting port of the N first connecting ports, the processing unit determines that a j-th first icon of the N first icons is corresponding to the i-th first connecting port and changes a display color of the j-th first icon, the input unit is used for moving the j-th first icon in the first peripheral device removing interface to a position corresponding to the i-th first connecting port, i is a positive integer smaller than or equal to N, j is a positive integer smaller than or equal to N.

According to the claimed invention, the display unit displays the j-th first icon by a first color when the peripheral device is connected to the i-th first connecting port and is transmitting data; the display unit displays the j-th first icon by a second color when the peripheral device is connected to the i-th first connecting port and is idle; and the display unit displays the j-th first icon by a third color when the peripheral device has not been connected to the i-th first connecting port yet.

According to the claimed invention, the display unit displays a second peripheral device removing interface and displays M second icons in the second peripheral device removing interface when a hub is connected to one of the N first connecting ports, the hub has M second connecting ports, M is a positive integer larger than one, the input unit is used for moving the M second icons in the second peripheral device removing interface to positions corresponding to the M second connecting ports.

According to the claimed invention, when a peripheral device is connected to a p-th second connecting port of the M second connecting ports, the processing unit determines that a q-th second icon of the M second icons is corresponding to the p-th second connecting port and changes a display color of the q-th second icon, the input unit is used for moving the q-th second icon in the second peripheral device removing interface to a position corresponding to the p-th second connecting port, p is a positive integer smaller than or equal to M, q is a positive integer smaller than or equal to M.

According to the claimed invention, the display unit displays the q-th second icon by a first color when the peripheral device is connected to the p-th second connecting port and is transmitting data; the display unit displays the q-th second icon by a second color when the peripheral device is connected to the p-th second connecting port and is idle; and the display unit displays the q-th second icon by a third color when the peripheral device has not been connected to the p-th second connecting port yet.

According to the claimed invention, the N first connecting ports and the M second connecting ports are universal serial bus connecting ports.

According to the claimed invention, a computer readable storage medium for storing a set of instructions, the set of instructions executes steps of displaying a first peripheral device removing interface in an electronic device, wherein the electronic device has N first connecting ports and N is a positive integer larger than one; displaying N first icons in the first peripheral device removing interface; and allowing a user to move the N first icons in the first peripheral device removing interface to positions corresponding to the N first connecting ports.

According to the claimed invention, the set of instructions executes steps of when a peripheral device is connected to an i-th first connecting port of the N first connecting ports, determining that a j-th first icon of the N first icons is corresponding to the i-th first connecting port and changing a display color of the j-th first icon, wherein i is a positive integer smaller than or equal to N, and j is a positive integer smaller than or equal to N; and allowing the user to move the j-th first icon in the first peripheral device removing interface to a position corresponding to the i-th first connecting port.

According to the claimed invention, the set of instructions executes steps of displaying the j-th first icon by a first color when the peripheral device is connected to the i-th first connecting port and is transmitting data; displaying the j-th first icon by a second color when the peripheral device is connected to the i-th first connecting port and is idle; and displaying the j-th first icon by a third color when the peripheral device has not been connected to the i-th first connecting port yet.

According to the claimed invention, the set of instructions executes steps of displaying a second peripheral device removing interface in the electronic device when a hub is connected to one of the N first connecting ports, wherein the hub has M second connecting ports and M is a positive integer larger than one; displaying M second icons in the second peripheral device removing interface; and allowing the user to move the M second icons in the second peripheral device removing interface to positions corresponding to the M second connecting ports.

According to the claimed invention, the set of instructions executes steps of when a peripheral device is connected to a p-th second connecting port of the M second connecting ports, determining that a q-th second icon of the M second icons is corresponding to the p-th second connecting port and changing a display color of the q-th second icon, wherein p is a positive integer smaller than or equal to M, and q is a positive integer smaller than or equal to M; and allowing the user to move the q-th second icon in the second peripheral device removing interface to a position corresponding to the p-th second connecting port.

According to the claimed invention, the set of instructions executes steps of displaying the q-th second icon by a first color when the peripheral device is connected to the p-th second connecting port and is transmitting data; displaying the q-th second icon by a second color when the peripheral device is connected to the p-th second connecting port and is idle; and displaying the q-th second icon by a third color when the peripheral device has not been connected to the p-th second connecting port yet.

As mentioned in the above, when the peripheral device removing program of the invention is executed, the peripheral device removing program detects the number of connecting ports of the electronic device and/or the hub automatically and display the same number of icons in the peripheral device removing interface. At this time, the user can move the icons in the peripheral device removing interface to the positions corresponding to the connecting ports. Accordingly, the user can perceive that one peripheral device, which he/she wants to remove, is connected to which connecting port rapidly according to the positions of the icons in the peripheral device removing interface and then removes the peripheral device rapidly and safely in the peripheral device removing interface. Furthermore, the invention may utilize different colors to show the connecting states between the peripheral devices and the connecting ports, so as to prevent the other peripheral devices, which are transmitting data, from being removed and then damaged.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an electronic device according to an embodiment of the invention.

FIG. 2 is a functional block diagram illustrating the electronic device shown in FIG. 1.

FIG. 3 is a schematic diagram illustrating a first peripheral device removing interface displayed by the display unit shown in FIG. 1.

FIG. 4 is a schematic diagram illustrating a peripheral device being connected to a first connecting port and a display color of a first icon in the first peripheral device removing interface being changed correspondingly.

FIG. 5 is a schematic diagram illustrating the first icons in the first peripheral device removing interface being moved to the positions corresponding to the first connecting ports.

FIG. 6 is a flowchart illustrating a method for setting a peripheral device removing interface according to an embodiment of the invention.

FIG. 7 is a schematic diagram illustrating two peripheral devices being connected to the first connecting ports and the first icons in the first peripheral device removing interface being displayed by different colors.

FIG. 8 is a schematic diagram illustrating a hub being connected to the first connecting port and a second peripheral device removing interface.

FIG. 9 is a schematic diagram illustrating the second icons in the second peripheral device removing interface being moved to the positions corresponding to the second connecting ports.

FIG. 10 is a flowchart illustrating a method for setting a peripheral device removing interface according to another embodiment of the invention.

### DETAILED DESCRIPTION

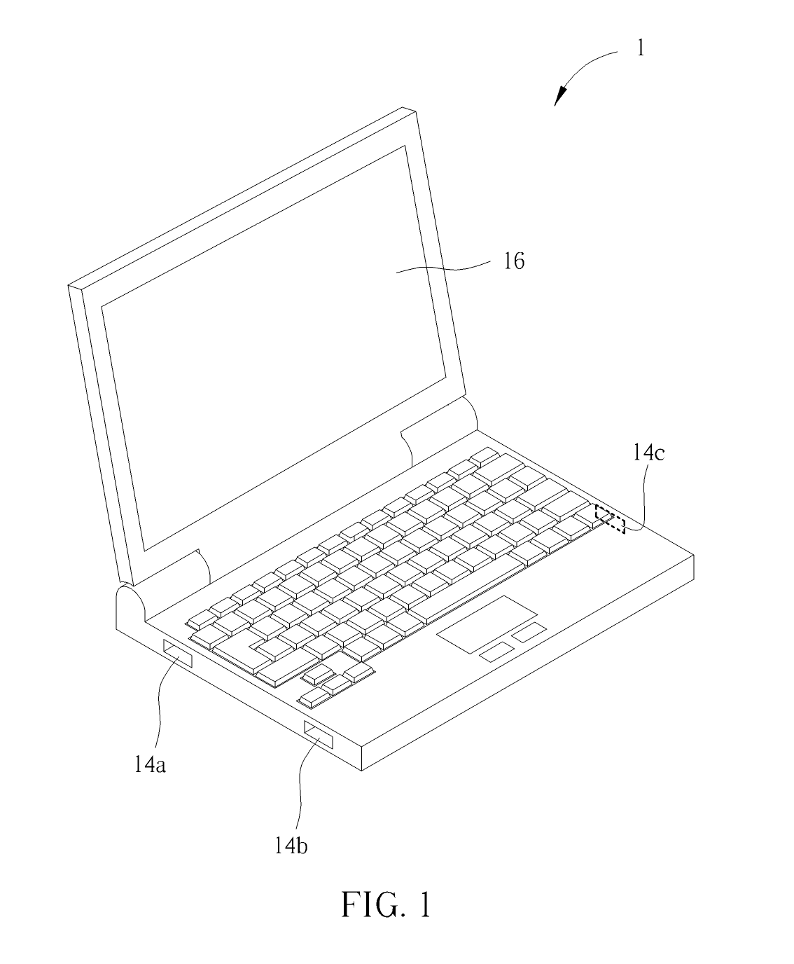

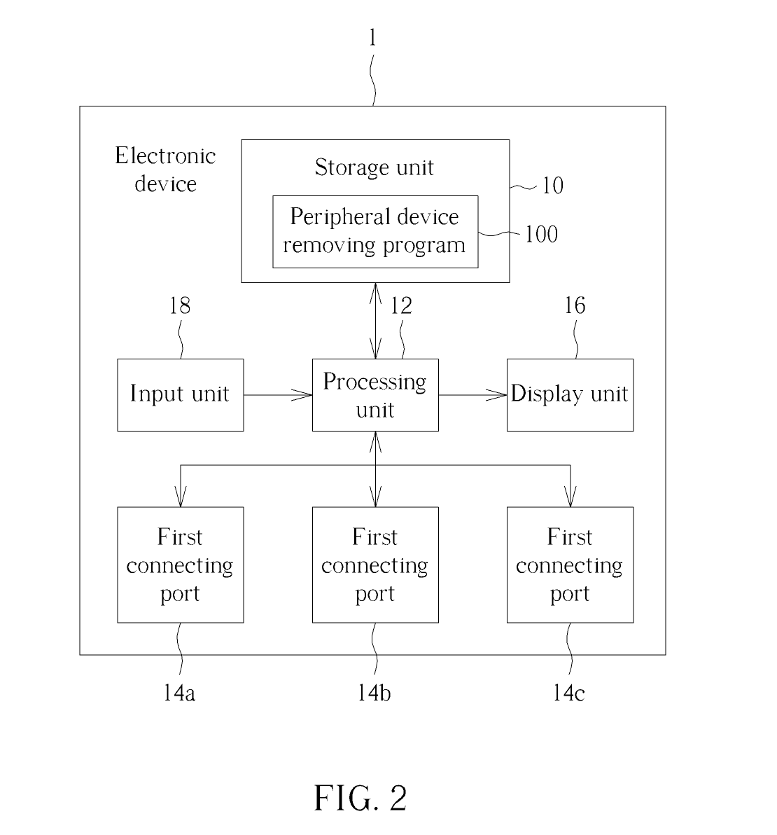

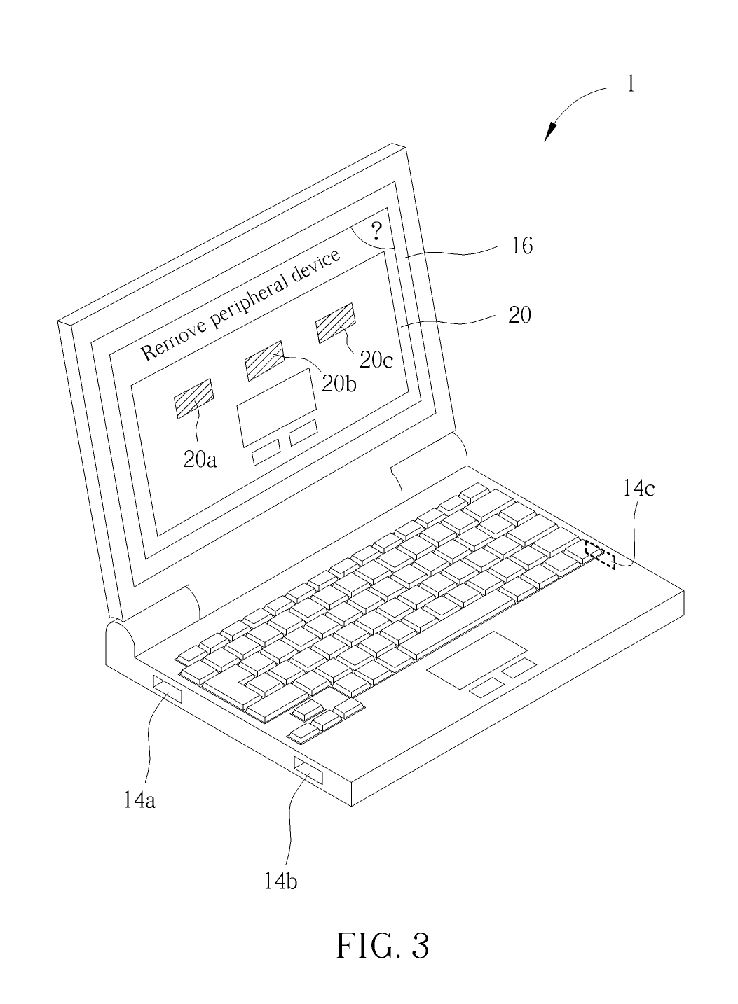

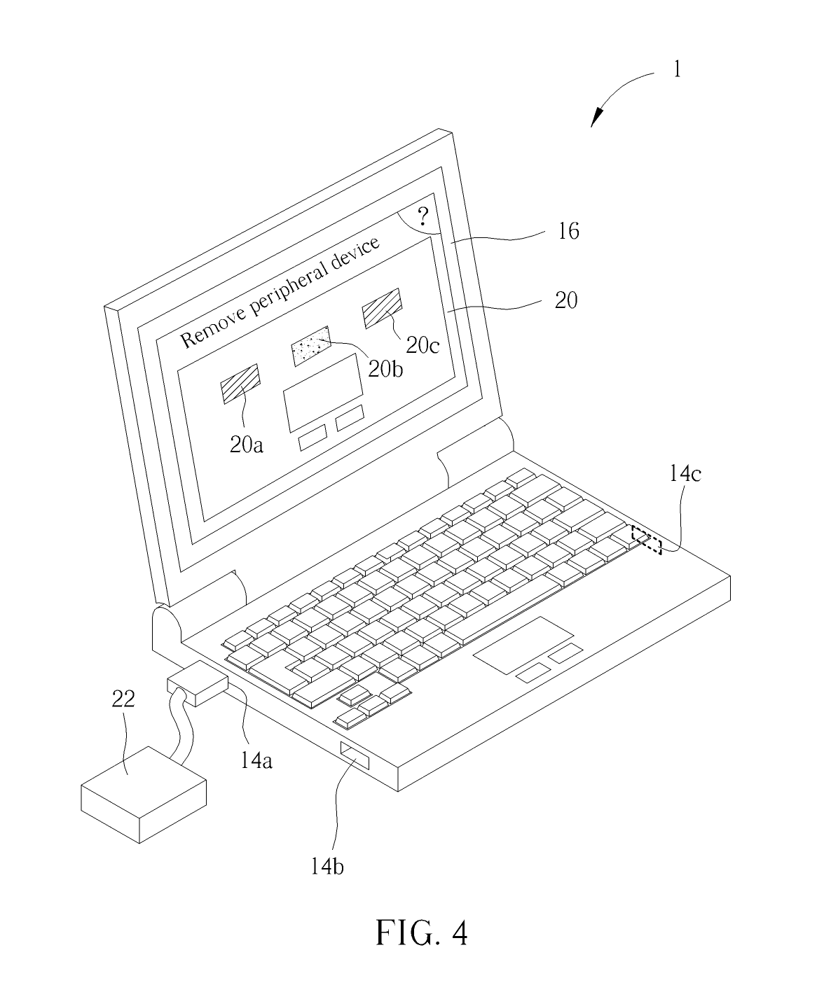

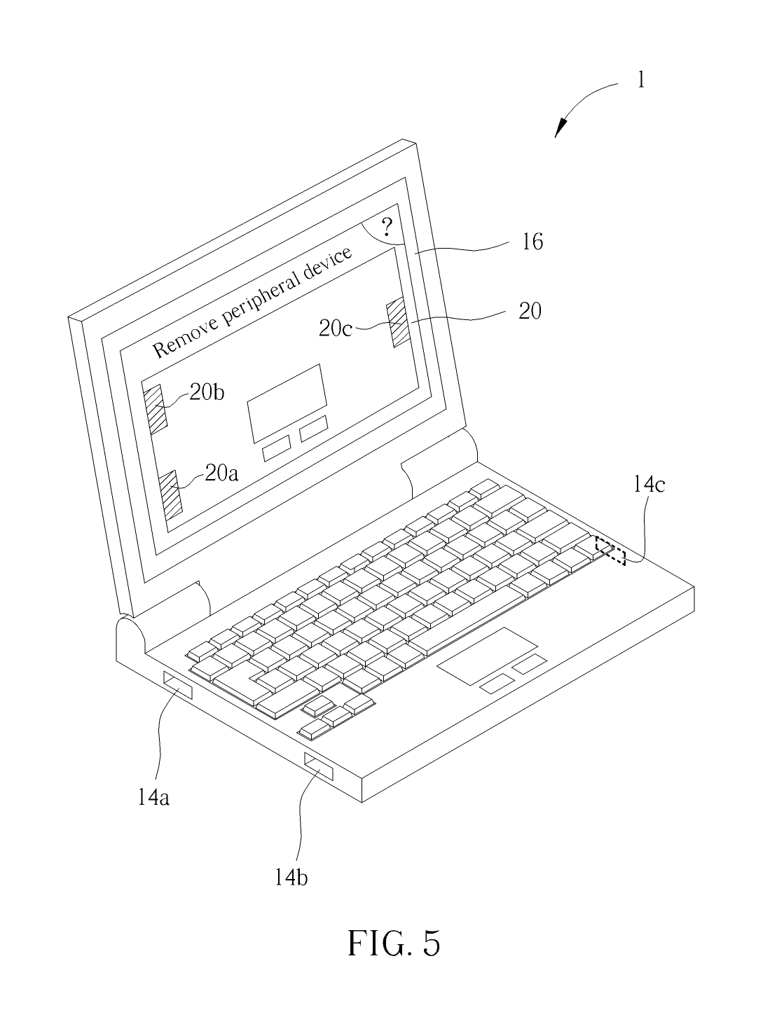

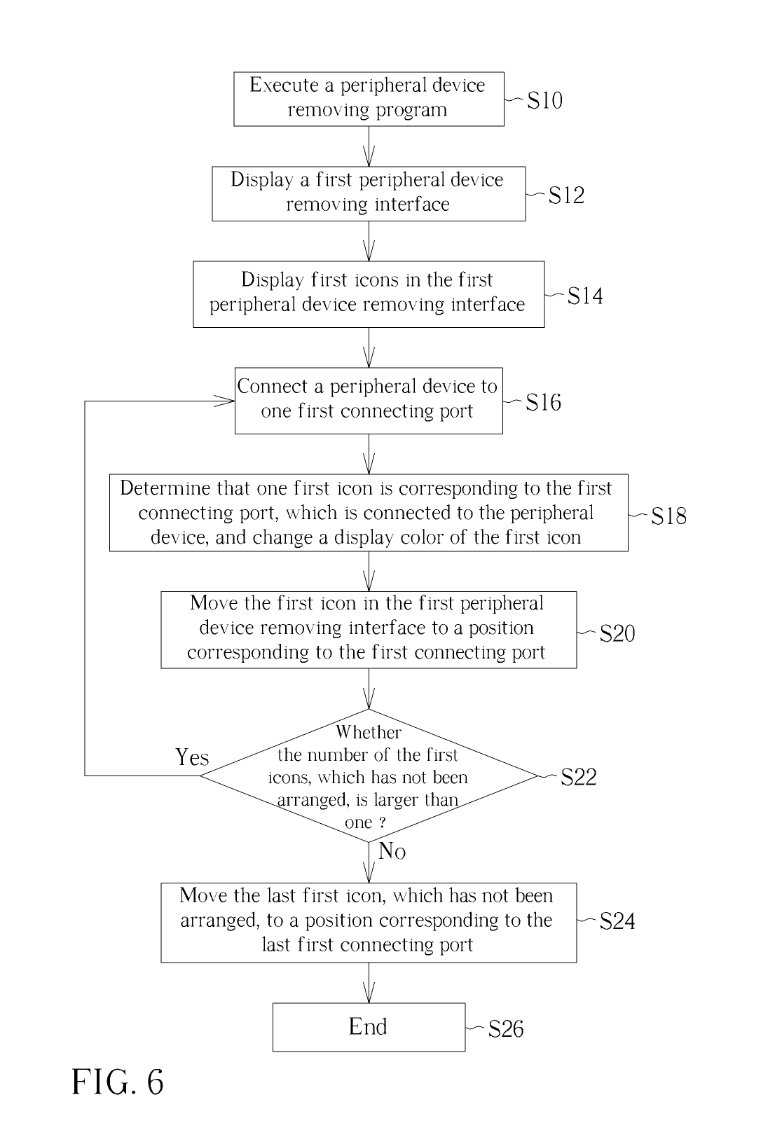

Referring to FIGS. 1 to 6, FIG. 1 is a schematic diagram illustrating an electronic device 1 according to an embodiment of the invention, FIG. 2 is a functional block diagram illustrating the electronic device 1 shown in FIG. 1, FIG. 3 is a schematic diagram illustrating a first peripheral device removing interface 20 displayed by the display unit 16 shown in FIG. 1, FIG. 4 is a schematic diagram illustrating a peripheral device 22 being connected to a first connecting port 14a and a display color of a first icon 20b in the first peripheral device removing interface 20 being changed correspondingly, FIG. 5 is a schematic diagram illustrating the first icons 20a, 20b, 20c in the first peripheral device removing interface 20 being moved to the positions corresponding to the first connecting ports 14a, 14b, 14c, and FIG. 6 is a flowchart illustrating a method for setting a peripheral device removing interface according to an embodiment of the invention. The method for setting a peripheral device removing interface shown in FIG. 6 can be implemented by the electronic device 1 shown in FIGS. 1 and 2.

As shown in FIGS. 1 and 2, the electronic device 1 comprises a storage unit 10, a processing unit 12, N first connecting ports 14a, 14b, 14c, a display unit 16 and an input unit 18, wherein the processing unit 12 is electrically connected to the storage unit 10, the first connecting ports 14a, 14b, 14c, the display unit 16 and the input unit 18, and N is a positive integer larger than one. There are three first connecting ports 14a, 14b, 14c used in this embodiment for illustration purpose (i.e. N=3). However, the number of the first connecting ports can be determined based on practical applications and are not limited to three. Furthermore, the first connecting ports 14a, 14b, 14c may be universal serial bus (USB) connecting ports or other plug and play connecting ports.

In practical applications, the electronic device 1 may be a personal computer, flat computer, notebook or other electronic devices with plug and play connecting ports; the storage unit 10 may be a hard disc, memory or other devices capable of storing data; the processing unit 12 may be a processor or controller with data calculating/processing function; the display unit 16 may be a liquid crystal display device or other display devices; the input unit 18 may be a keyboard, mouse, touch device or other input devices. In general, the electronic device 1 may be further equipped with some necessary hardware or software components for specific purposes, such as a power supply, an operating system, a communication module, etc., and it depends on practical applications.

As shown in FIG. 2, the storage unit 10 is used for storing a peripheral device removing program 100 and the processing unit 12 is used for executing the peripheral device removing program 100 after booting. When the peripheral device removing program 100 is executed (step S10 in FIG. 6), the display unit 16 displays a first peripheral device removing interface 20 (step S12 in FIG. 6). At the same time, the peripheral device removing program 100 detects the number of the first connecting ports 14a, 14b, 14c of the electronic device 1 automatically and displays the same number of first icons 20a, 20b, 20c in the first peripheral device removing interface 20 (step S14 in FIG. 6), as shown in FIG. 3. It should be noted that when the peripheral device removing program 100 of the invention is executed in the beginning, the first icons 20a, 20b, 20c displayed in the first peripheral device removing interface 20 is not corresponding to the actual positions of the first connecting ports 14a, 14b, 14c of the electronic device 1 yet. Therefore, a user has to adjust the positions of the first icons 20a, 20b, 20c when initiating the first peripheral device removing interface 20.

As shown in FIG. 4, the user may connect a peripheral device 22 to the first connecting port 14a of the three first connecting ports 14a, 14b, 14c (step S16 in FIG. 6). When the peripheral device 22 is connected to the first connecting port 14a, the processing unit 12 determines that which one of the first icons 20a, 20b, 20c is corresponding to the first connecting port 14a. In this embodiment, the processing unit 12 determines that the first icon 20b is corresponding to the first connecting port 14a, which is connected to the peripheral device 22, and changes a display color of the first icon 20b (step S18 in FIG. 6), so as to give a notice to the user. Afterward, the user can operate the input unit 18 to move the first icon 20b in the first peripheral device removing interface 20 to a position corresponding to the first connecting port 14a (step S20 in FIG. 6). Then, the user or the processing unit 12 determines that whether the number of the first icons, which has not been arranged, is larger than one (step S22 in FIG. 6). If the number of the first icons, which has not been arranged, is larger than one, steps S16 to S20 are repeated. If the number of the first icons, which has not been arranged, is not larger than one (i.e. equal to one), step S24 is then performed to move the last first icon, which has not been arranged, to a position corresponding to the last first connecting port. Accordingly, the user can move all of the first icons 20a, 20b, 20c in the first peripheral device removing interface 20 to the positions corresponding to all of the first connecting ports 14a, 14b, 14c. As shown in FIG. 5, the first icon 20a is corresponding to the first connecting port 14b, the first icon 20b is corresponding to the first connecting port 14a, and the first icon 20c is corresponding to the first connecting port 14c. After arranging all of the first icons, step S26 is performed to end the execution.

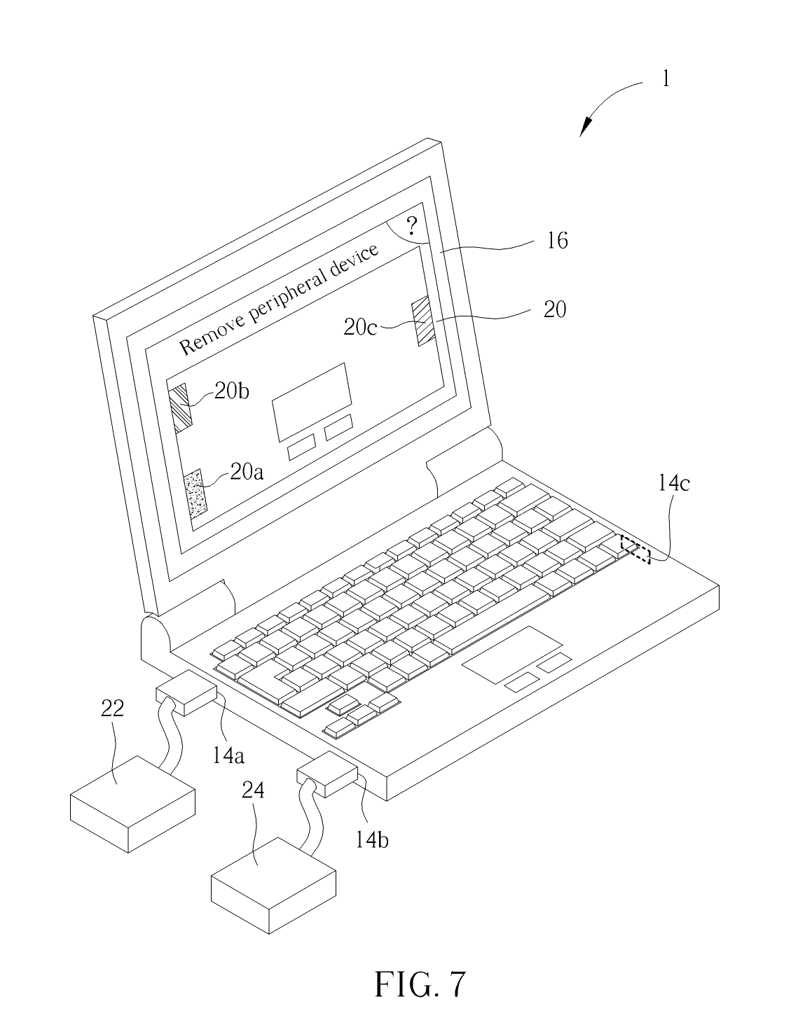

Referring to FIG. 7, FIG. 7 is a schematic diagram illustrating two peripheral devices 22, 24 being connected to the first connecting ports 14a, 14b and the first icons 20a, 20b, 20c in the first peripheral device removing interface 20 being displayed by different colors. As shown in FIG. 7, the display unit 16 displays the first icon 20b by a first color (e.g. red) when the peripheral device 22 is connected to the first connecting port 14a and is transmitting data; the display unit 16 displays the first icon 20a by a second color (e.g. green) when the peripheral device 24 is connected to the first connecting port 14b and is idle; and the display unit 16 displays the first icon 20c by a third color (e.g. yellow) when the peripheral device has not been connected to the first connecting port 14c yet. Accordingly, the user can perceive the connecting states between the peripheral devices and the first connecting ports by different colors, so as to prevent the peripheral devices, which are transmitting data, from being removed and then damaged. For example, since the first icon 20a is displayed by the second color, the peripheral device 24, which is connected to the first connecting port 14b, is idle, such that the user can operate the input unit 18 to click the first icon 20a so as to remove the peripheral device 24 safely.

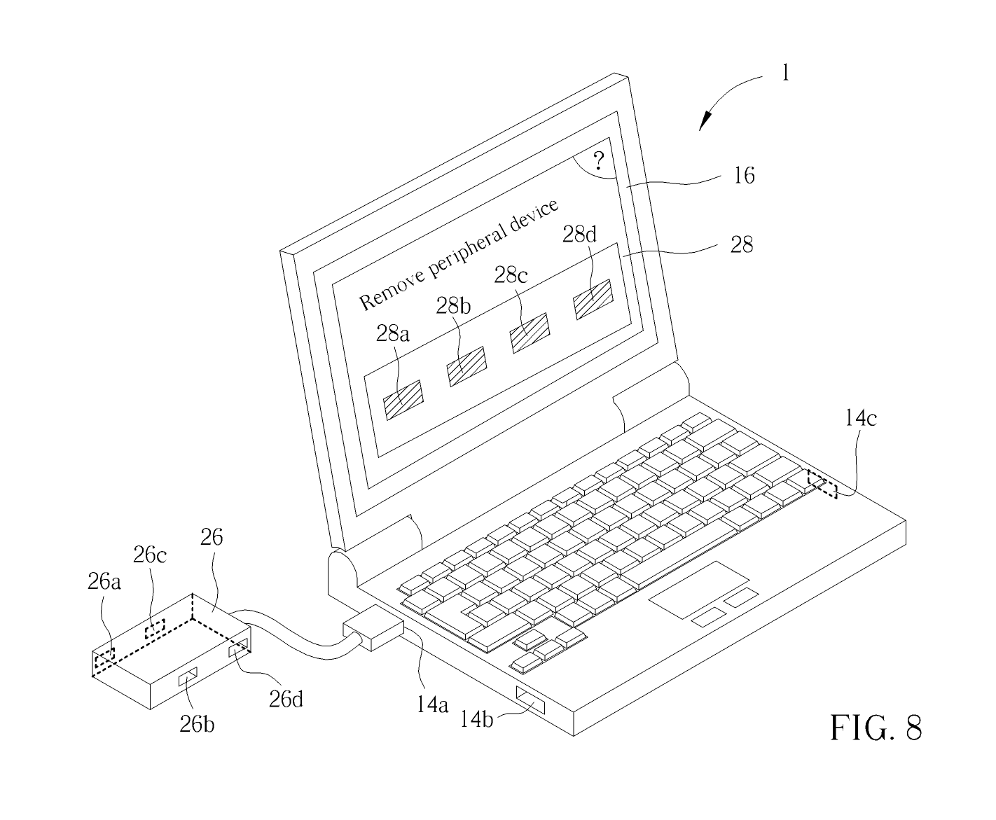

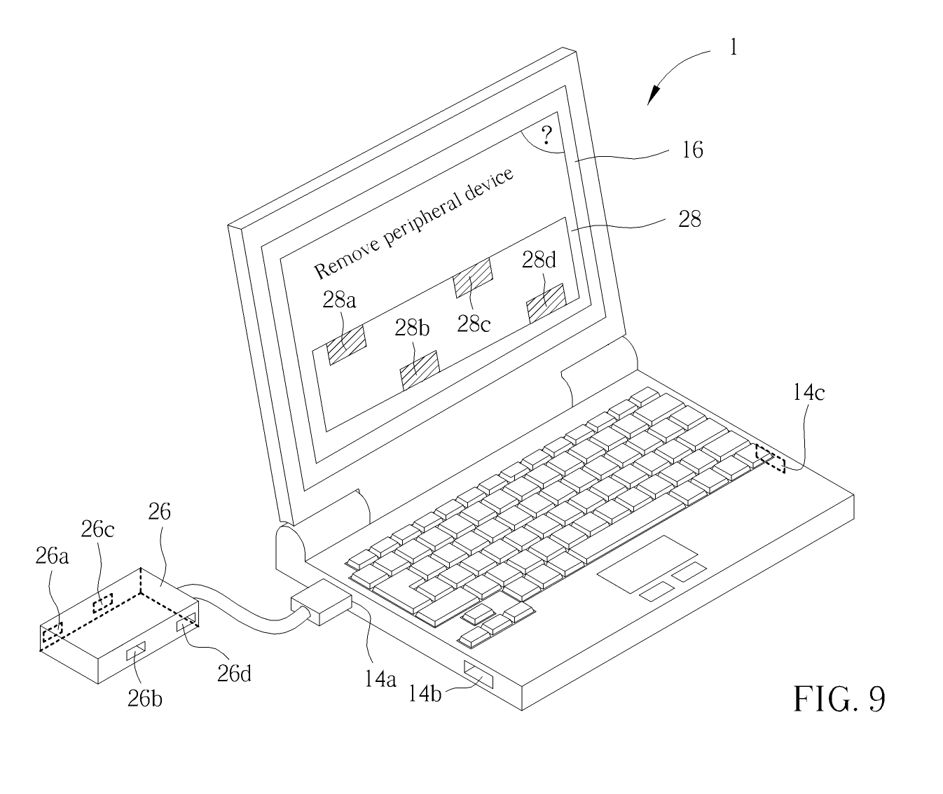

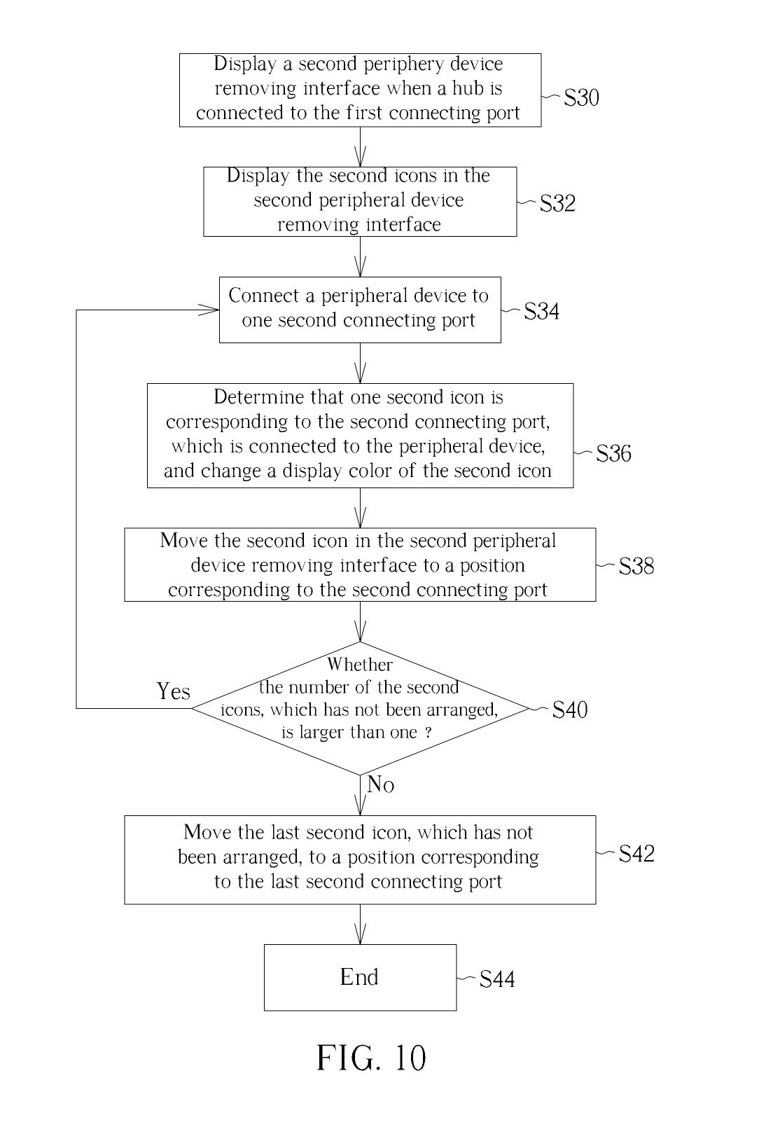

Referring to FIGS. 8 to 10, FIG. 8 is a schematic diagram illustrating a hub 26 being connected to the first connecting port 14a and a second peripheral device removing interface 28, FIG. 9 is a schematic diagram illustrating the second icons 28a, 28b, 28c, 28d in the second peripheral device removing interface 28 being moved to the positions corresponding to the second connecting ports 26a, 26b, 26c, 26d, and FIG. 10 is a flowchart illustrating a method for setting a peripheral device removing interface according to another embodiment of the invention.

As shown in FIG. 8, when a hub 26 is connected to the first connecting port 14a, the peripheral device removing program 100 is executed to display a second periphery device removing interface 28 in the display unit 16 (step S30 in FIG. 10), wherein the hub 26 has M second connecting ports 26a, 26b, 26c, 26d and M is a positive integer larger than one. There are four second connecting ports 26a, 26b, 26c, 26d used in this embodiment for illustration purpose (i.e. M=4). However, the number of the second connecting ports can be determined based on practical applications and are not limited to four. Furthermore, the second connecting ports 26a, 26b, 26c, 26d may be universal serial bus (USB) connecting ports or other plug and play connecting ports.

The peripheral device removing program 100 will detect the number of the second connecting ports 26a, 26b, 26c, 26d of the hub 26 automatically and displays the same number of second icons 28a, 28b, 28c, 28d in the second peripheral device removing interface 28 (step S32 in FIG. 10), as shown in FIG. 8. As mentioned in the above, the second icons 28a, 28b, 28c, 28d displayed in the second peripheral device removing interface 28 is not corresponding to the actual positions of the second connecting ports 26a, 26b, 26c, 26d of the hub 26 yet. Therefore, the user has to adjust the positions of the second icons 28a, 28b, 28c, 28d when initiating the second peripheral device removing interface 28.

As mentioned in the above, the user may connect a peripheral device to one of the second connecting ports 26a, 26b, 26c, 26d (step S34 in FIG. 10). For example, when the peripheral device is connected to the second connecting port 26a, the processing unit 12 determines that which one of the second icons 28a, 28b, 28c, 28d is corresponding to the second connecting port 26a. In this embodiment, the processing unit 12 determines that the second icon 28a is corresponding to the second connecting port 26a, which is connected to the peripheral device, and changes a display color of the second icon 28a (step S36 in FIG. 10), so as to give a notice to the user. Afterward, the user can operate the input unit 18 to move the second icon 28a in the second peripheral device removing interface 28 to a position corresponding to the second connecting port 26a (step S38 in FIG. 10). Then, the user or the processing unit 12 determines that whether the number of the second icons, which has not been arranged, is larger than one (step S40 in FIG. 10). If the number of the second icons, which has not been arranged, is larger than one, steps S34 to S38 are repeated. If the number of the second icons, which has not been arranged, is not larger than one (i.e. equal to one), step S42 is then performed to move the last second icon, which has not been arranged, to a position corresponding to the last second connecting port. Accordingly, the user can move all of the second icons 28a, 28b, 28c, 28d in the second peripheral device removing interface 28 to the positions corresponding to all of the second connecting ports 26a, 26b, 26c, 26d. As shown in FIG. 9, the second icon 28a is corresponding to the second connecting port 26a, the second icon 28b is corresponding to the second connecting port 26b, the second icon 28c is corresponding to the second connecting port 26c, and the second icon 28d is corresponding to the second connecting port 26d. After arranging all of the first icons, step S44 is performed to end the execution.

In other words, when the peripheral device connected to the connecting port of the electronic device 1 is a hub, the user can also arrange the positions of the second icons 28a, 28b, 28c, 28d relative to the second connecting ports 26a, 26b, 26c, 26d through the second peripheral device removing interface 28.

Similarly, the display unit 16 may display the second icons 28a, 28b, 28c or 28d by a first color (e.g. red) when the peripheral device is connected to the second connecting ports 26a, 26b, 26c or 26d and is transmitting data correspondingly; the display unit 16 may display the second icons 28a, 28b, 28c or 28d by a second color (e.g. green) when the peripheral device is connected to the second connecting ports 26a, 26b, 26c or 26d and is idle correspondingly; and the display unit 16 may display the second icons 28a, 28b, 28c or 28d by a third color (e.g. yellow) when the peripheral device has not been connected to the second connecting ports 26a, 26b, 26c or 26d yet. Accordingly, the user can perceive the connecting states between the peripheral devices and the second connecting ports by different colors, so as to prevent the peripheral devices, which are transmitting data, from being removed and then damaged.

It should be noted that the aforesaid peripheral device removing program 100 and the control logic of the method for setting the peripheral device removing interface can be implemented by software. The software can be executed in any electronic devices with connecting ports. Needless to say, each part or function of the control logic may be implemented by software, hardware or the combination thereof. Moreover, the peripheral device removing program 100 can be embodied by a computer readable storage medium, wherein the computer readable storage medium stores instructions, which can be executed by an electronic device so as to generate control command for executing corresponding function.

It should be noted that, in the peripheral device removing program 100 of the invention, after setting the positions of the first icons 20a, 20b, 20c corresponding to the first connecting ports 14a, 14b, 14c, the positions of the first icons 20a, 20b, 20c will not be changed anymore. In other words, when the user opens the first peripheral device removing interface 20 of the peripheral device removing program 100 again, the image shown in FIG. 7 will be displayed in the first peripheral device removing interface 20 immediately. Furthermore, the second peripheral device removing interface 28 will be displayed only when the hub 26 is connected to one of the first connecting ports of the electronic device 1. Similarly, after setting the positions of the second icons 28a, 28b, 28c or 28d corresponding to the second connecting ports 26a, 26b, 26c or 26d, the positions of the second icons 28a, 28b, 28c or 28d will not be changed anymore. In other words, when the user opens the second peripheral device removing interface 28 of the peripheral device removing program 100 again, the image shown in FIG. 9 will be displayed in the second peripheral device removing interface 28 immediately. The user has to reset the positions of the second icons corresponding to the second connecting ports only when another hub is connected to one of the first connecting ports of the electronic device 1.

As mentioned in the above, when the peripheral device removing program of the invention is executed, the peripheral device removing program detects the number of connecting ports of the electronic device and/or the hub automatically and display the same number of icons in the peripheral device removing interface. At this time, the user can move the icons in the peripheral device removing interface to the positions corresponding to the connecting ports. Accordingly, the user can perceive that one peripheral device, which he/she wants to remove, is connected to which connecting port rapidly according to the positions of the icons in the peripheral device removing interface and then removes the peripheral device rapidly and safely in the peripheral device removing interface. Furthermore, the invention may utilize different colors to show the connecting states between the peripheral devices and the connecting ports, so as to prevent the other peripheral devices, which are transmitting data, from being removed and then damaged.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for setting peripheral device removing interface comprising steps of:
displaying a first peripheral device removing interface in an electronic device, wherein the electronic device has N first connecting ports and N is a positive integer larger than one;
displaying N first icons in the first peripheral device removing interface; and
moving the N first icons in the first peripheral device removing interface to positions corresponding to the N first connecting ports.

2. The method of claim 1, wherein the step of moving the N first icons in the first peripheral device removing interface to positions corresponding to the N first connecting ports comprises steps of:
connecting a peripheral device to an i-th first connecting port of the N first connecting ports, wherein i is a positive integer smaller than or equal to N;
determining that a j-th first icon of the N first icons is corresponding to the i-th first connecting port and changing a display color of the j-th first icon, wherein j is a positive integer smaller than or equal to N; and
moving the j-th first icon in the first peripheral device removing interface to a position corresponding to the i-th first connecting port.

3. The method of claim 2, further comprising steps of:
displaying the j-th first icon by a first color when the peripheral device is connected to the i-th first connecting port and is transmitting data;
displaying the j-th first icon by a second color when the peripheral device is connected to the i-th first connecting port and is idle; and
displaying the j-th first icon by a third color when the peripheral device has not been connected to the i-th first connecting port yet.

4. The method of claim 1, further comprising steps of:
displaying a second peripheral device removing interface in the electronic device when a hub is connected to one of the N first connecting ports, wherein the hub has M second connecting ports and M is a positive integer larger than one;
displaying M second icons in the second peripheral device removing interface; and
moving the M second icons in the second peripheral device removing interface to positions corresponding to the M second connecting ports.

5. The method of claim 4, wherein the step of moving the M second icons in the second peripheral device removing interface to positions corresponding to the M second connecting ports comprises steps of:
connecting a peripheral device to a p-th second connecting port of the M second connecting ports, wherein p is a positive integer smaller than or equal to M;
determining that a q-th second icon of the M second icons is corresponding to the p-th second connecting port and changing a display color of the q-th second icon, wherein q is a positive integer smaller than or equal to M; and
moving the q-th second icon in the second peripheral device removing interface to a position corresponding to the p-th second connecting port.

6. The method of claim 5, further comprising steps of:
displaying the q-th second icon by a first color when the peripheral device is connected to the p-th second connecting port and is transmitting data;
displaying the q-th second icon by a second color when the peripheral device is connected to the p-th second connecting port and is idle; and
displaying the q-th second icon by a third color when the peripheral device has not been connected to the p-th second connecting port yet.

7. The method of claim 4, wherein the N first connecting ports and the M second connecting ports are universal serial bus connecting ports.

8. An electronic device comprising:
a storage unit for storing a peripheral device removing program;
a processing unit electrically connected to the storage unit and used for executing the peripheral device removing program;
N first connecting ports electrically connected to the processing unit, N being a positive integer larger than one;
a display unit electrically connected to the processing unit, the display unit displaying a first peripheral device removing interface and displaying N first icons in the first peripheral device removing interface when the peripheral device removing program is executed; and
an input unit electrically connected to the processing unit and used for moving the N first icons in the first peripheral device removing interface to positions corresponding to the N first connecting ports.

9. The electronic device of claim 8, wherein when a peripheral device is connected to an i-th first connecting port of the N first connecting ports, the processing unit determines that a j-th first icon of the N first icons is corresponding to the i-th first connecting port and changes a display color of the j-th first icon, the input unit is used for moving the j-th first icon in the first peripheral device removing interface to a position corresponding to the i-th first connecting port, i is a positive integer smaller than or equal to N, j is a positive integer smaller than or equal to N.

10. The electronic device of claim 9, wherein the display unit displays the j-th first icon by a first color when the peripheral device is connected to the i-th first connecting port and is transmitting data; the display unit displays the j-th first icon by a second color when the peripheral device is connected to the i-th first connecting port and is idle; and the display unit displays the j-th first icon by a third color when the peripheral device has not been connected to the i-th first connecting port yet.

11. The electronic device of claim 8, wherein the display unit displays a second peripheral device removing interface and displays M second icons in the second peripheral device removing interface when a hub is connected to one of the N first connecting ports, the hub has M second connecting ports, M is a positive integer larger than one, the input unit is used for moving the M second icons in the second peripheral device removing interface to positions corresponding to the M second connecting ports.

12. The electronic device of claim 11, wherein when a peripheral device is connected to a p-th second connecting port of the M second connecting ports, the processing unit determines that a q-th second icon of the M second icons is corresponding to the p-th second connecting port and changes a display color of the q-th second icon, the input unit is used for moving the q-th second icon in the second peripheral device removing interface to a position corresponding to the p-th second connecting port, p is a positive integer smaller than or equal to M, q is a positive integer smaller than or equal to M.

13. The electronic device of claim 12, wherein the display unit displays the q-th second icon by a first color when the peripheral device is connected to the p-th second connecting port and is transmitting data; the display unit displays the q-th second icon by a second color when the peripheral device is connected to the p-th second connecting port and is idle; and the display unit displays the q-th second icon by a third color when the peripheral device has not been connected to the p-th second connecting port yet.

14. The electronic device of claim 11, wherein the N first connecting ports and the M second connecting ports are universal serial bus connecting ports.

15. A computer readable storage medium for storing a set of instructions, the set of instructions executing steps of:
displaying a first peripheral device removing interface in an electronic device, wherein the electronic device has N first connecting ports and N is a positive integer larger than one;
displaying N first icons in the first peripheral device removing interface; and
allowing a user to move the N first icons in the first peripheral device removing interface to positions corresponding to the N first connecting ports.

16. The computer readable storage medium of claim 15, the set of instructions executing steps of:
when a peripheral device is connected to an i-th first connecting port of the N first connecting ports, determining that a j-th first icon of the N first icons is corresponding to the i-th first connecting port and changing a display color of the j-th first icon, wherein i is a positive integer smaller than or equal to N, and j is a positive integer smaller than or equal to N; and
allowing the user to move the j-th first icon in the first peripheral device removing interface to a position corresponding to the i-th first connecting port.

17. The computer readable storage medium of claim 16, the set of instructions executing steps of:
displaying the j-th first icon by a first color when the peripheral device is connected to the i-th first connecting port and is transmitting data;
displaying the j-th first icon by a second color when the peripheral device is connected to the i-th first connecting port and is idle; and
displaying the j-th first icon by a third color when the peripheral device has not been connected to the i-th first connecting port yet.

18. The computer readable storage medium of claim 15, the set of instructions executing steps of:
displaying a second peripheral device removing interface in the electronic device when a hub is connected to one of the N first connecting ports, wherein the hub has M second connecting ports and M is a positive integer larger than one;
displaying M second icons in the second peripheral device removing interface; and
allowing the user to move the M second icons in the second peripheral device removing interface to positions corresponding to the M second connecting ports.

19. The computer readable storage medium of claim 18, the set of instructions executing steps of:
when a peripheral device is connected to a p-th second connecting port of the M second connecting ports, determining that a q-th second icon of the M second icons is corresponding to the p-th second connecting port and changing a display color of the q-th second icon, wherein p is a positive integer smaller than or equal to M, and q is a positive integer smaller than or equal to M; and
allowing the user to move the q-th second icon in the second peripheral device removing interface to a position corresponding to the p-th second connecting port.

20. The computer readable storage medium of claim 19, the set of instructions executing steps of:
displaying the q-th second icon by a first color when the peripheral device is connected to the p-th second connecting port and is transmitting data;
displaying the q-th second icon by a second color when the peripheral device is connected to the p-th second connecting port and is idle; and
displaying the q-th second icon by a third color when the peripheral device has not been connected to the p-th second connecting port yet.
